(19) United States
(12) Patent Application Publication
(10) Pub. No.: US 2005/0116076 A1
(43) Pub. Date: Jun. 2, 2005

(54) Jaw crusher bucket

(76) Inventor: Gregory Noel Went, Tunarry, NSW (AU)

Correspondence Address: PEARNE & GORDON LLP, 1801 EAST 9TH STREET, SUITE 1200, CLEVELAND, OH, 44114-3108, US

(21) Appl. No.: 10/501,976

(22) PCT Filed: Jan. 17, 2003
(86) PCT No.: PCT/AU03/00062

(30) Foreign Application Priority Data
Jan. 17, 2002 (AU) PS 0413

(51) Int. Cl. B02C 1/10

(52) U.S. Cl. 241/291

(57) ABSTRACT

A jaw crusher bucket (50) for attaching to a front-end loader or excavator has a plurality of rock and concrete splitting teeth (56), and jaw means (52, 54) for crushing any large pieces of rubble split from the rock or concrete into smaller pieces. There is a stationary jaw (52) which supports the teeth (56), and a pivotally movable jaw (54) which is able to move by a hydraulic ram (67) to cause the movable jaw (54) to be urged towards the stationary jaw (52) and so crush the rubble.

### TECHNICAL FIELD

The present invention relates to a jaw crusher bucket for use in splitting and crushing large pieces of rubble, such as large boulders and chunks of concrete at a quarry or demolition site.

### BACKGROUND ART

Conventional rock quarrying methods result in the accumulation of stockpiles of large boulders split from the quarry rock face that require crushing. At present, the crushing of excavated large boulders is achieved with the use of dedicated rock breaking machinery and is both time consuming and noisy due to the hammering process involved. Similarly, the demolition of concrete slab structures often produces large pieces or chunks of concrete requiring crushing for efficient disposal at tips and land fill sites.

There is a high cost associated with using dedicated rock and concrete breaking machinery which, when coupled to the high fees for disposing of large boulders and pieces of concrete at tips and land fill sites, encourages their illegal dumping at remote road sides and the like.

It is an object of the present invention to provide a jaw crusher bucket which eliminates the need to use the dedicated rock and concrete breaking machinery of the prior art. It is another object of the invention to provide a jaw crusher bucket which serves both as a rock and concrete splitter and as a crusher of large pieces of rubble that may result from the splitting.

### DISCLOSURE OF INVENTION

According to the present invention, there is provided a jaw crusher bucket for attaching to a front-end loader or excavator, comprising a plurality of rock and concrete splitting teeth, and jaw means for crushing any large pieces of rubble split from the rock or concrete into smaller pieces.

The jaw means of the jaw crusher bucket preferably comprises a stationary jaw and a movable jaw.

It is preferred that the stationary jaw includes the rock and concrete splitting teeth, which extend from a mouth of the jaw crusher bucket.

In a preferred form, the jaw crusher bucket includes hydraulic ram means to enable movement of the movable jaw when under the control of a driver of a front-end loader or excavator.

Preferably, the jaw crusher bucket includes a gap between the stationary jaw and the movable jaw remote of the mouth for allowing the crushed smaller pieces of rubble to fall therethrough.

### BRIEF DESCRIPTION OF THE DRAWINGS

FIG. 1 is a side elevational view of a front-end loader, to which a jaw crusher bucket according to a preferred embodiment of the present invention is attached, being operated to load a large piece of rubble into the bucket,

FIG. 2 is a side elevational view of the front-end loader of FIG. 1 in which the jaw crusher bucket has been manoeuvred to an upright position for crushing the large piece of rubble into smaller pieces,

FIG. 3 is a simplified side view of a jaw crusher bucket according to one form of the invention for crushing large pieces of split concrete,

FIG. 4 is a simplified rear perspective view of the jaw crusher bucket shown in FIG. 3,

FIG. 5 is a detailed rear perspective view of a preferred jaw crusher bucket of the invention for crushing large boulders,

FIG. 6 is a part sectional side view of the jaw crusher bucket shown in FIG. 5,

FIG. 7 is a front perspective view of a toggle lever used in the jaw crusher bucket shown in FIGS. 5 and 6,

FIG. 8 is a perspective view of the crushing surface side of the movable jaw of the jaw crusher bucket shown in FIGS. 5 and 6,

FIG. 9 is a side elevational view of an excavator, to which a preferred jaw rusher bucket of the present invention is attached, being operated to crush a large piece of rubble into smaller pieces,

FIG. 10 is a side elevational view of an underground mining vehicle, to which a preferred jaw crusher bucket of the present invention is attached, being operated to load a large piece of rubble into the bucket,

FIG. 11 is a simplified side view of a jaw crusher bucket according to another embodiment of the invention, in which the mounting location of the movable jaw is adjustable,

FIG. 12 is a more detailed front perspective view of a main housing assembly of the jaw crusher bucket of FIG. 11,

FIG. 13 is a more detailed front perspective view of a movable jaw mounting assembly of the jaw crusher bucket of FIG. 11,

FIG. 14 is a more detailed front perspective view of a toggle lever of the jaw crusher bucket of FIG. 11, and

FIG. 15 is a more detailed front perspective view of a movable jaw of the jaw crusher bucket of FIG. 11.

### MODES FOR CARRYING OUT THE INVENTION

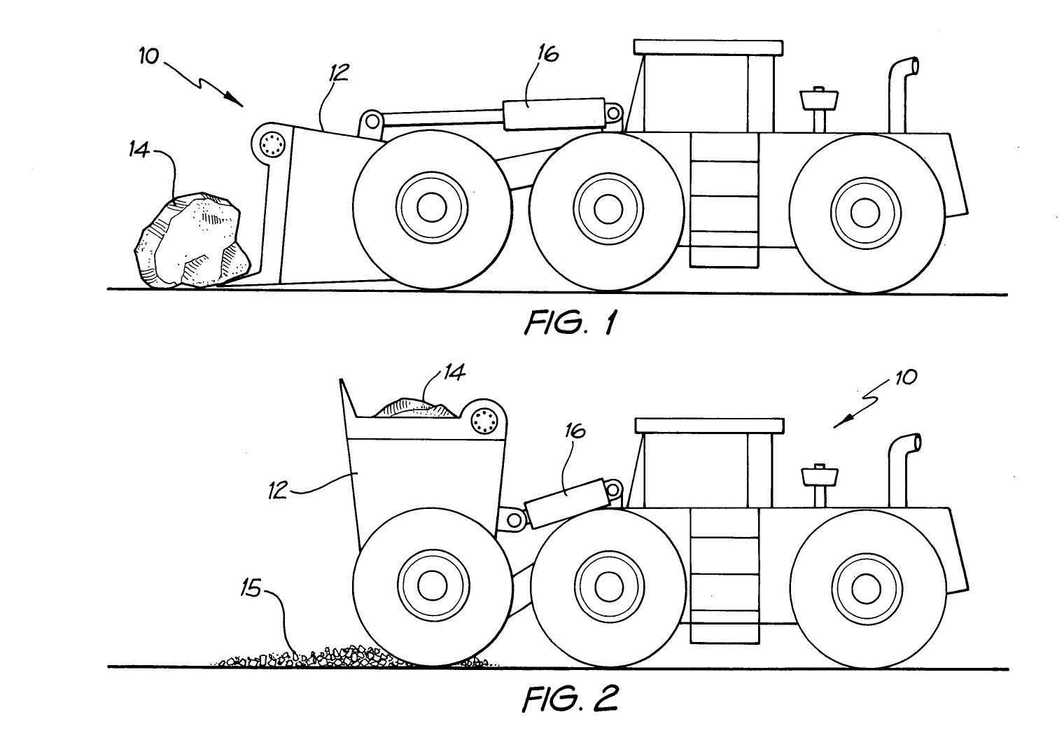

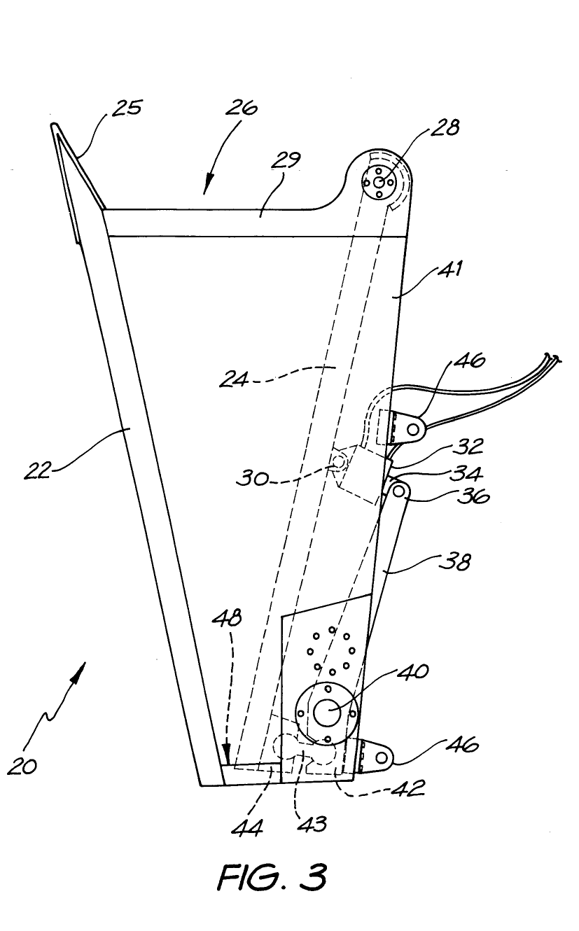

The front-end loader 10 shown in FIGS. 1 and 2 has operably attached thereto a jaw crusher bucket 12 which can be operated by the driver of the loader 10 to pivot about axle mounts (not shown) between the tilted loading position of FIG. 1, where a large piece of rubble 14 is being loaded into the bucket 12, and the upright crushing position of FIG. 2. The pivotal motion of the bucket 12 is guided by a hydraulic ram 16. Smaller, crushed pieces of rubble 15 are shown in FIG. 2.

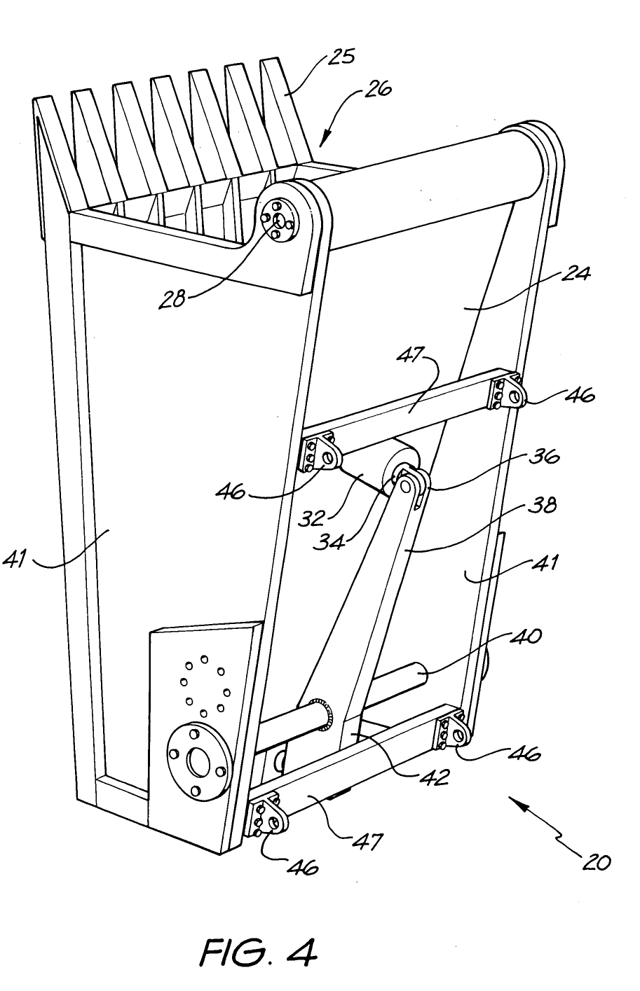

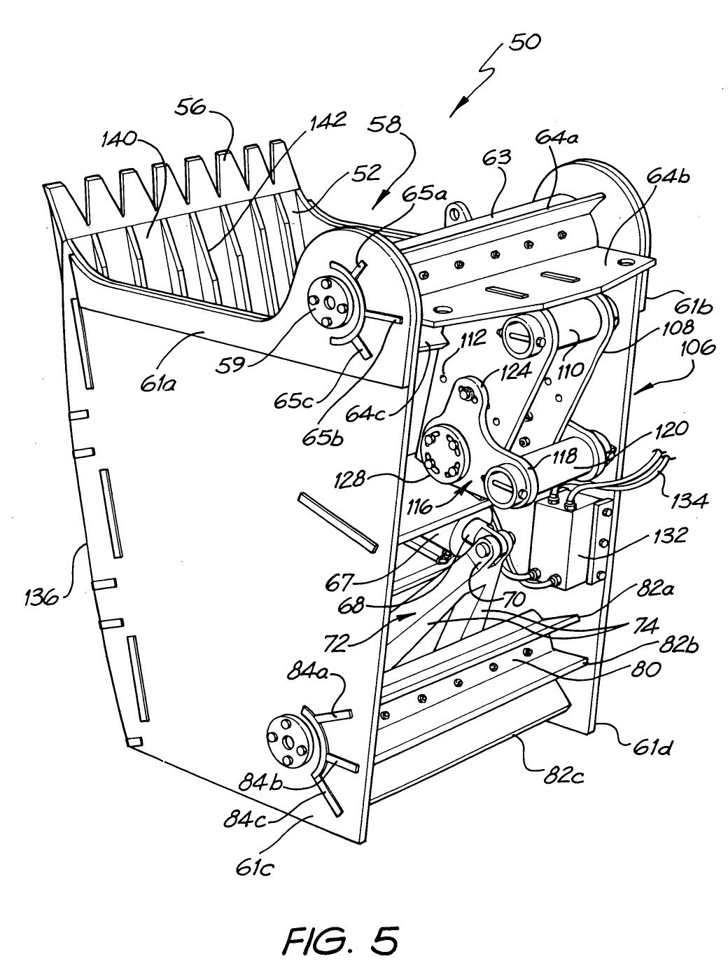

The jaw crusher bucket 20 shown in simplified view in FIGS. 3 and 4 has a stationary jaw 22 and a movable jaw 24. Extending from the top of the stationary jaw 22 are a plurality of rock and concrete splitting teeth 25 that define a front side of a mouth 26 of the bucket 20. The movable jaw 24 is rotatably mounted at the rear side of the mouth 26 by a shaft assembly 28. The sides of the mouth 26 joining the stationary jaw 22 and the movable jaw 24 are strengthened by reinforcing plates 29. Connected to the rear of the movable jaw 24 via a mounting flange 30 is the cylinder end of a hydraulic ram 32, the extendable and retractable rod 34 of which is engaged to a first end 36 of a toggle lever 38. The toggle lever 38 is pivotally mounted via a pivot shaft 40 to opposed sides 41 of the bucket 20, and a recess in the kinked second end 42 of the lever 38 receives one end of a dog bone shaped link arm 43. The other end of the link arm 43 is received in a recess formed in a push plate 44 which is secured to the rear of the movable jaw 24. There are upper and lower pairs of loader mounting hitch flanges 46 secured to the rear cross members 47 of the bucket 20 for receiving the bucket tilt operating arm assembly (not shown) of the loader or excavator to which the bucket 20 is attached.

Crushed smaller pieces of rock and concrete fall through a bottom gap 48 between the stationary jaw 22 and the movable jaw 24 remote of the mouth 26. The driver operates the ram 32 to extend its rod 34 and cause the toggle lever 38 to pivot in a clockwise direction (relative to FIGS. 3 and 4) and so cause the movable jaw 24 to pivot in the same direction, bringing it closer to the stationary jaw 22 and thus crushing large pieces of rubble loaded in the bucket 20.

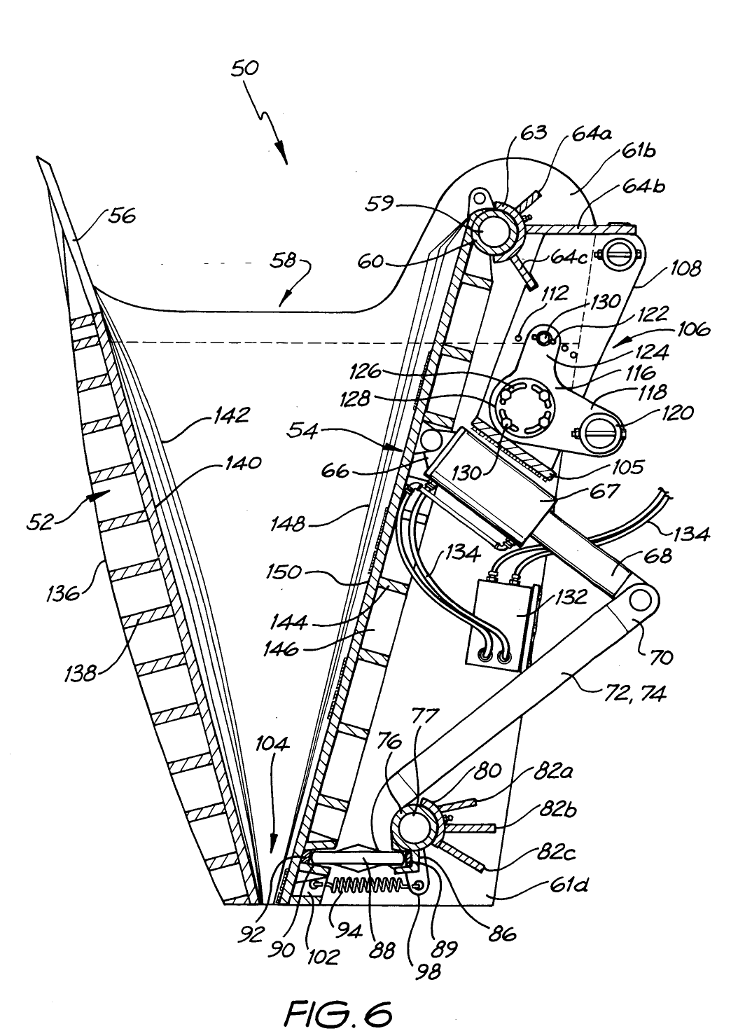

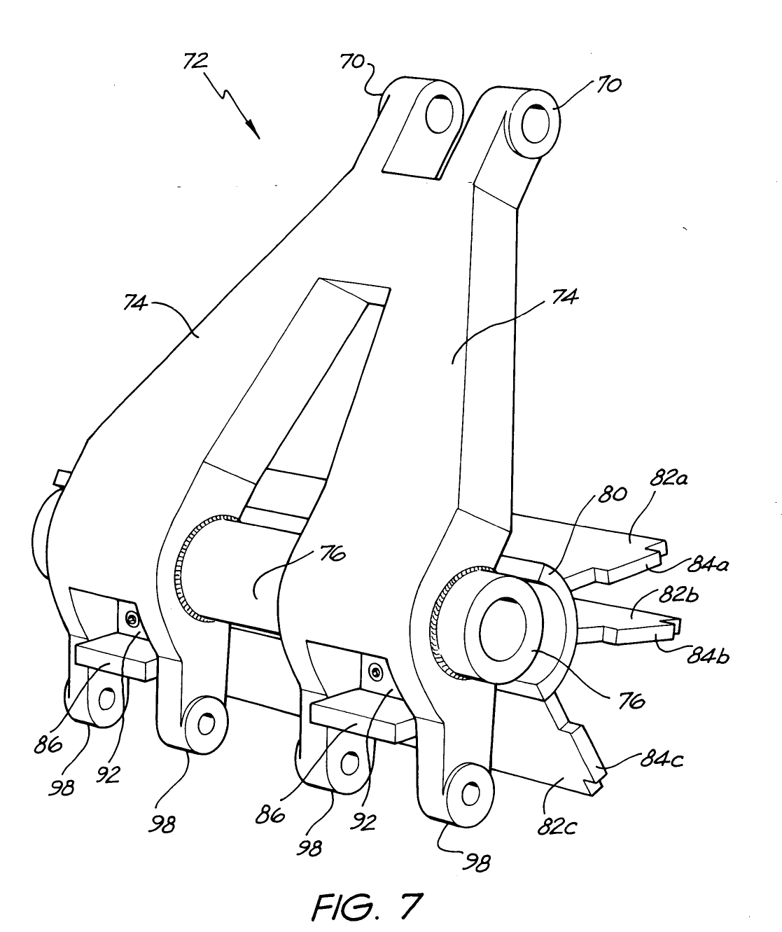

The jaw crusher bucket 50 shown in FIGS. 5 and 6 is similar in function to that shown in FIGS. 4 and 5, and has a stationary jaw 52, a movable jaw 54 and a row of teeth 56. The movable jaw 54 is rotatably mounted at the rear of the mouth 58 opposite the teeth 56 by a shaft 59 housed in a bush 60 and secured to strengthened opposed upper sides 61a, 61b of the bucket 50. There is a load bearing cradle 63 for the jaw bush 60, and stabilising web plates 64a, 64b, 64c extend radially from the cradle 63 and have opposed side key portions 65a, 65b, 65c that fit securely into slots formed through the sides 61a, 61b of the bucket 50. There are a pair of mounting flanges 66 on the rear of the movable jaw 54 to which are connected a hydraulic ram 67 partly located therebetween. The reciprocating rod 68 of the ram 67 is pivotally attached to upper mounting flanges 70 of a toggle lever 72 (shown in detail in FIG. 7). The toggle lever 72 has a downwardly flared bifurcated body 74 that joins to a bush 76 that houses a shaft 77 for allowing the toggle lever 72 to rotate under control of the ram 67. The shaft 77 is mounted to opposed lower sides 61c, 61d of the bucket 50. There is a load bearing cradle 80 for the toggle bush 76, and stabilising web plates 82a, 82b, 82c extend radially from the cradle 80 and have opposed side key portions 84a, 84b, 84c that fit securely into slots formed through the bucket sides 61c, 61d. Extending from the toggle bush 76 are a pair of seats 86, each of which receive a first end of a strengthened push block 88 of a desired length against replaceable wear plate 89 of the seat 86. The other end of each push block 88 is received in a socket 90 at the rear of the movable jaw 54, each socket 90 having a replaceable wear plate 92 against which the push block 88 urges by pivotal operation of the toggle lever 72. Heavy duty coil springs 94 are connected at respective first ends thereof to a respective lower flanged portion 98 of the toggle lever 72 and are connected at respective second ends thereof to a respective plate 102 at the rear of the movable jaw 54.

The springs 94 cause the movable jaw 54 to retract from the stationary jaw 52 when the ram 67 is operated to retract its rod 68 and cause the toggle lever 72 to pivot in an anticlockwise direction (relative to FIG. 6), and so allow crushed, small pieces of rock and concrete to fall through a bottom gap 104 between the stationary jaw 52 and movable jaw 54.

Slottedly secured to web plates 64b and 105, which rigidly span the opposed sides 61 of the bucket 50 behind the movable jaw 54, is a hitch mounting assembly 106 comprising a pair of brackets 108 interconnected by a cylinder mount 110 for rotatably receiving a first part of a bucket tilt operating arm assembly (not shown) of, say, a front-end loader. Each bracket 108 has a series of radially spaced apart pin adjustment holes 112 and a plurality of pin insertion holes (obscured by nuts 114 shown in FIG. 5) adapted for engaging a respective, positionally adjustable, hitch elbow 116. Each hitch elbow 116 has a forearm portion 118, and the two forearm portions 118 are interconnected by a cylinder mount 120 for rotatably receiving a second part of the bucket tilt operating arm assembly. There is a radial slot 122 formed through the upper arm portion 124 and there is a series of radially spaced apart adjustment slots 126 formed through the reinforced joint portion 128 of each hitch elbow 116. The location of the radial slot 122 in a hitch elbow 116 can overlap with the location of the pin adjustment holes 112 in an adjacent bracket 108, and the location of the adjustment slots 126 in a hitch elbow 116 can overlap with the location of the pin insertion holes in an adjacent bracket 108, so that a hitch elbow 116 can be secured to its adjacent bracket 108 at a selected one of a predetermined number of positions by lock pins or bolts 130, thus enabling the bucket 50 to be operably attached to a variety of operating arm assembly configurations.

Fixed to the inner surface of a side wall 61 of the bucket 50 is a pressure release valve system 132 (protected by a casing 133) for controlling the flow of hydraulic fluid through the hoses 134 to and from the ram 67. The valve system 132 provides automatic termination of the operation of the hydraulic ram 67 if the movable jaw 54 experiences excessive crushing resistance.

The stationary jaw 52 of jaw crusher bucket 50 has a convexly curved outer face 136 to facilitate the splitting from a quarry rock face or from a concrete slab of rubble. A point on the face 136 may act as a pivotal fulcrum for manoeuvring the bucket 50 during manipulation against the rock face or concrete slab. The stationary jaw 52 has reinforcing cross-ribs 138 at its outer face 136. There are convexly tapered piercing splines 142 on its inner face 140, the height of the piercing splines 142 from the inner face 140 being greater about half way down the jaw 52 than near the mouth 58 or near the bottom gap 104. Also, the more centrally located splines 142 extend forwardly from the inner face 140 to a greater extent than the splines 142 located towards the edges thereof, thus presenting a convex profile of the splines 142 in two perpendicular directions. The splines 142 of the stationary jaw 52 facilitate the bending and resultant splitting and crushing of large concrete pieces loaded in the bucket 50 when the movable jaw 54 is urged towards the stationary jaw 52.

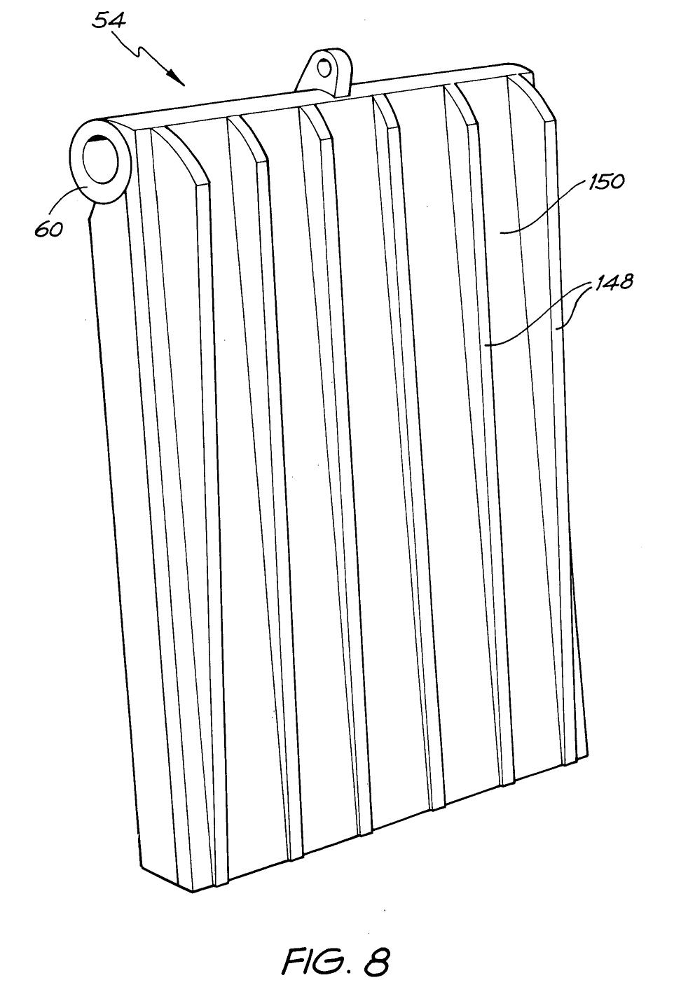

The movable jaw 54 of jaw crusher bucket 50 has, at its rear face, reinforcing cross-ribs 144 interconnected by reinforcing upright ribs. There are generally inwardly tapered grinding and crushing ribs 148 extending downwardly the full length of its inner face 150 (as shown in FIG. 8). Also, the more centrally located ribs 148 extend forwardly from the inner face 150 to a lesser extent than the ribs 148 located towards the edges thereof, thus presenting a concave profile in the horizontal direction and an inwardly tapered profile in the vertical direction. The ribs 148 facilitate the grinding of rubble loaded in the bucket 50 during its jaw crushing operation.

The excavator 152 shown in FIG. 9 has operably attached thereto a jaw crusher bucket 154, that is being operated by the driver of the excavator 152 to firstly crush large pieces of rubble 156, which it has split from a rock face and loaded in the bucket 154, and secondly deposit the resulting small pieces of rubble 158 upon the ground as may be necessary for stockpiling of useful rubble pieces. The resulting small pieces of rubble 158 may alternatively be loaded onto a truck for transportation to a required landfill or other site, or may be loaded into a cone crusher or the like for further processing of the small pieces of rubble into gravel and smaller particles.

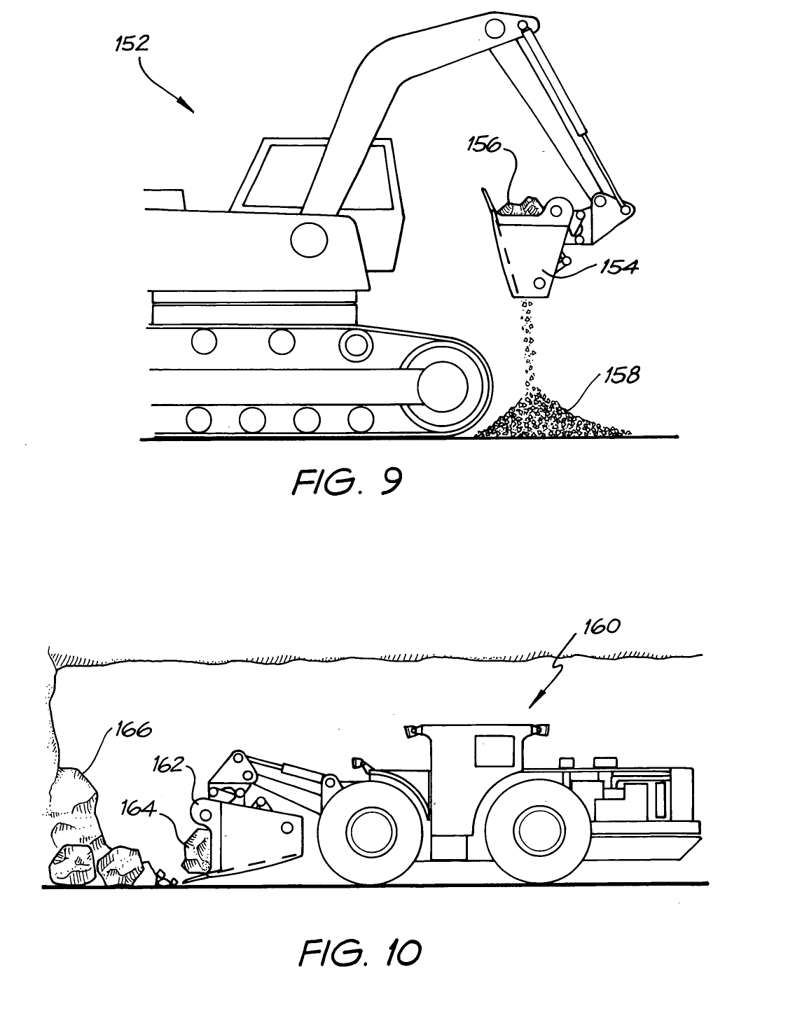

The underground mining vehicle 160 shown in FIG. 10 has operably attached thereto a jaw crusher bucket 162 and has been operated by the vehicle's driver to split a large rock 164 from a mine face 166 and to scoop it into the bucket 162, the large rock 164 then to be subject to the jaw crushing operation of the bucket 162.

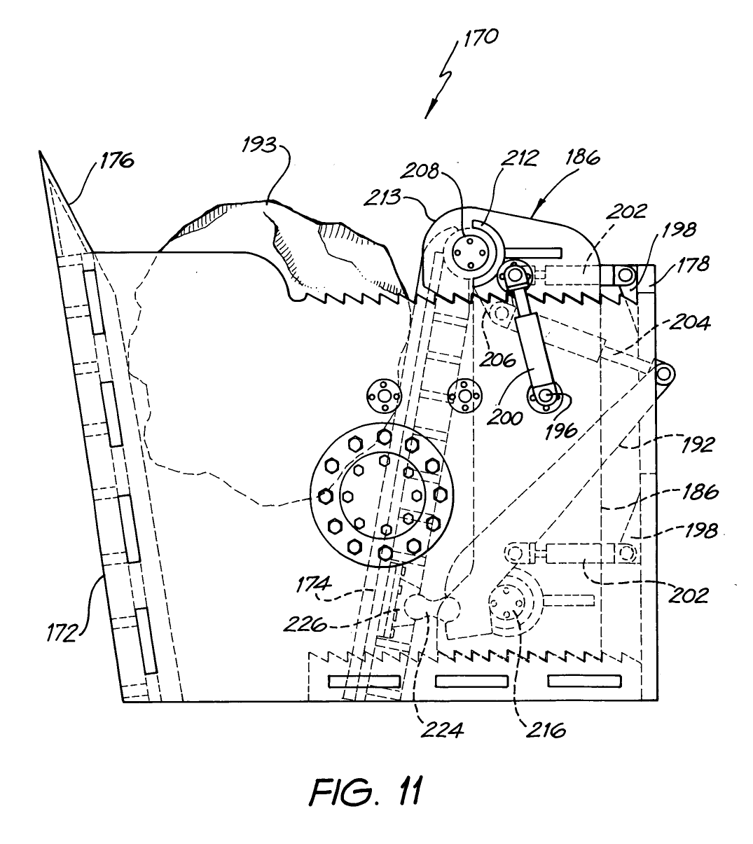

The jaw crusher bucket 170 shown in FIG. 11, whilst particularly suited for use on underground mining vehicles, is similar in basic function to the bucket shown in FIGS. 5 and 6, and has a stationary jaw 172, a movable jaw 174 and a row of teeth 176. The mounting location of the movable jaw 174 is, however, adjustable to any of a predetermined number of locations opposite the stationary jaw 172.

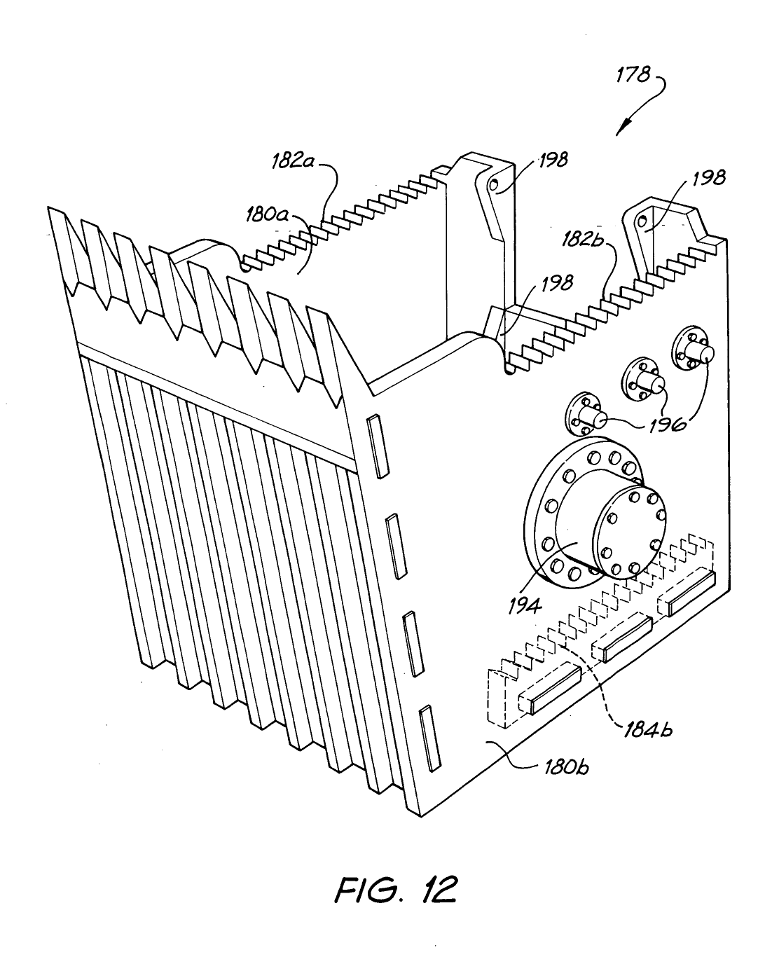

As shown more clearly in FIG. 12, the opposed sides 180a, 180b of a main housing assembly 178 of the bucket 170 include respective top teeth defining portions 182a, 182b along an upper edge, and respective, upwardly facing, bottom teeth defining portions 184a, 184b on the inside surfaces of the opposed sides 180a, 180b.

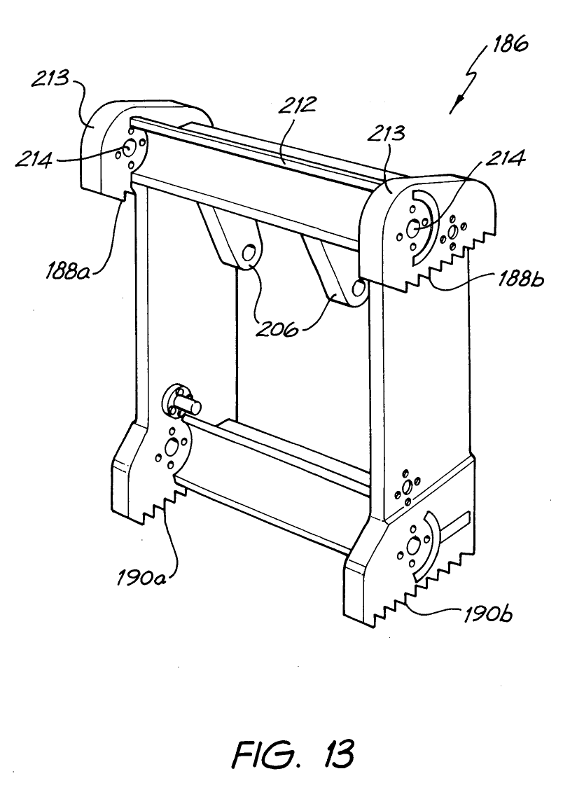

There is a movable jaw mounting assembly 186, shown more clearly in FIG. 13, which has opposed, downwardly facing, top teeth defining portions 188a, 188b on the outside surfaces of the assembly 186, and opposed, downwardly facing, bottom teeth defining portions 190a, 190b along a lower edge of the assembly 186.

The top teeth defining portions are adapted to intermesh (182a with 188a, and 182b with 188b), as are the bottom teeth defining portions (184a with 190a, and 184b with 190b), when the movable jaw mounting assembly 186 is located at its desired adjustment position with the main housing assembly 178, thereby defining new fixed positions for pivoting of the movable jaw crusher 174, and for pivoting the toggle lever 192, and for mounting of hitches and flanges of the bucket 170 to the vehicle. The adjustable relocation of the movable jaw 174 with respect to the stationary jaw 172 will be of benefit to crushing rubble of a wide variety of sizes and mass, see massive rock 193 in FIG. 11.

The main housing assembly 178 includes a pair of opposed main pivot axles 194, and lift ram mounting shafts 196 and push ram brackets 198 for mounting lift rams 200 and push rams 202 respectively. When desired, the lift rams 200 lift the movable jaw mounting assembly 186 from its intermeshed engagement with the main housing assembly 178, and the push rams 202 push (or pull) the disengaged movable jaw mounting assembly 186 forwards or backwards to a desired location before the lift rams 200 lower the movable jaw mounting assembly 186 back into intermeshed engagement with the main housing assembly 178 but at a thus adjusted mounting location of the movable jaw 174.

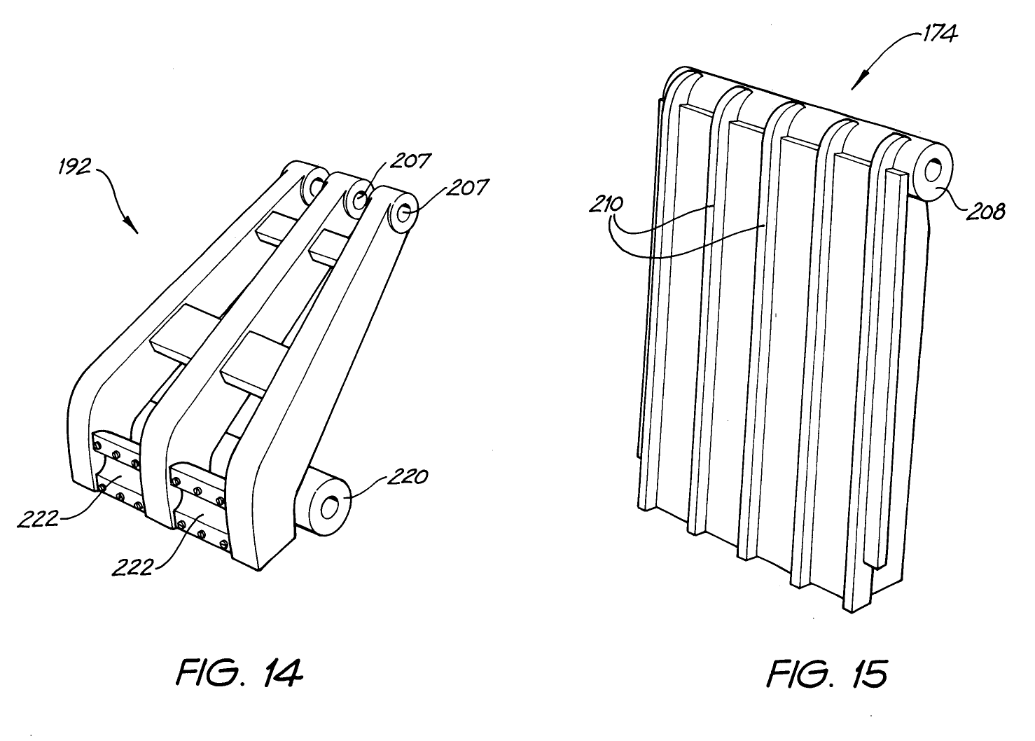

There are a pair of hydraulic rams 204 for operating the toggle lever 192. The rams 204 are connected at their cylinder ends to brackets 206 mounted on the movable jaw mounting assembly 186 and at their rod ends to the mounting apertures 207 (see FIG. 14) of the toggle lever 192.

The movable jaw 174 includes a bushing 208 for receiving therethrough a pivot shaft, and crushing ribs 210 projecting from the rock crushing face of the jaw 174. The bushing 208 is housed lengthwise in a cradle 212 and between the opposed forward extensions 213 of the top teeth defining portions 188a, 188b through which holes 214 are formed to receive the ends of the pivot shaft. Lock bolts secure the pivot shaft for the toggle lever 192 to the movable jaw mounting assembly 186.

The toggle lever 192 has a bushing 220 for receiving therethrough a pivot shaft 216, and a pair of seats 222 for receiving one end of respective dog bone shaped link arms 224. The other end of each link arm 224 is received in a respective recess formed in a push plate 226, a pair of which are secured to the rear of the movable jaw 174.

Various modifications may be made in details of design and construction without departing from the scope or ambit of the invention.

For instance, a guillotine and magnets may be fitted at the bottom gap of the jaw crusher bucket, particularly one that is designed to crush steel reinforced concrete slab pieces. Unwanted steel waste from the slab may thus be isolated from the small crushed concrete pieces deposited from the bucket.

Also, a hydraulic ram may be connected to the stationary jaw for operating the movement of the teeth thereon so as to further facilitate manoeuvring and the splitting of boulders from rock faces and concrete chunks from slabs.

Still further, the crushing surfaces of the stationary and movable jaws may be replaceable by bolt-on prefabricated plates having piercing splines or ribs of a desired configuration formed thereon.

1. A jaw crusher bucket for attaching to a front-end loader or excavator, comprising a plurality of rock and concrete splitting teeth, and jaw means for crushing any large pieces of rubble split from the rock or concrete into smaller pieces.

2. The jaw crusher bucket of claim 1 wherein the jaw means comprises a stationary jaw and a movable jaw.

3. The jaw crusher bucket of claim 2 wherein the stationary jaw includes the rock and concrete splitting teeth, which extend from a mouth of the jaw crusher bucket.

4. The jaw crusher bucket of claim 2 including hydraulic ram means to enable movement of the movable jaw when under the control of a driver of a front-end loader or excavator.

5. The jaw crusher bucket of claim 3 including a gap between the stationary jaw and the movable jaw remote of the mouth for allowing the crushed smaller pieces of rubble to fall therethrough.

6. The jaw crusher bucket of claim 2 wherein the movable jaw is pivotally movable.

7. The jaw crusher bucket of claim 4 wherein the hydraulic ram means causes pivotal movement of a toggle lever which, in turn, causes pivotal movement of the movable jaw.

8. The jaw crusher bucket of claim 1 including bracket means which support mounting means for a first part of a bucket tilt operating arm assembly of a front-end loader or excavator, and which support hitch means for a second part of the bucket tilt operating arm assembly, the mounting position of the hitch means on the bracket means being adjustable for enabling the bucket to be operably attached to various configurations of operating arm assembly.
